(19) United States
(12) Patent Application Publication
(10) Pub. No.: US 2012/0318303 A1
(43) Pub. Date: Dec. 20, 2012

(54) NON-BLEACHING PROCEDURE FOR THE REMOVAL OF TEA AND COFFEE STAINS

(75) Inventors: ALTONY J. MIRALLES, Woodbury, MN (US); MICHELLE FUNG, Eden Prairie, MN (US); JOHN KRUEGER, Rosemont, MN (US)

(73) Assignee: ECOLAB USA INC., St. Paul, MN (US)

(21) Appl. No.: 13/159,467

(22) Filed: Jun. 14, 2011

(51) Int. Cl. B08B 3/08; C11D 3/60

(52) U.S. Cl. 134/28; 510/218

(57) ABSTRACT

A novel approach to the removal of coffee and tea stains from dishes is disclosed. Tea, coffee and other stains caused by tannins are particularly difficult to remove and traditional techniques include harsh treatments that use bleach, or other environmentally undesirable chemicals such as phosphates, EDTA, NTA or other aminocarboxylates. Applicants have found that an acid rinse prior to alkaline cleaning of stained dishware such as ceramics porcelain and the like can remove up to one hundred percent of even aged coffee and tea stains.

### FIELD OF THE INVENTION

This invention relates to the field of dishwashing and stain removal. A method is disclosed to remove coffee and tea stains from ceramic, porcelain and the like without the need for bleach, phosphates, EDTA, NTA or other aminocarboxylates.

### BACKGROUND OF THE INVENTION

Machine dishwashing detergents constitute a generally recognized distinct class of detergent compositions. In general, machine dishwashing detergents are mixtures of ingredients whose purpose, in combination, is to breakdown and remove food soils; to inhibit foaming caused by certain food soils; to promote the wetting of wash articles in order to minimize or eliminate visually observable spotting and filming; to remove stains such as might be caused by beverages such as coffee and tea or by vegetable soils such as carotenoid soils; to prevent a buildup of soil films on wash ware surfaces; and to reduce or eliminate tarnishing of flatware.

The high tannic acid content in coffee and tea represent a particularly difficult problem for cleaning. These drinks often lead to stubborn brown stains on dishes, glasses, coffee mugs and teacups. Traditionally, alkaline products containing chlorine bleach have been used for this purpose. Many such products also use high (20% or more) levels of phosphate builders. Chlorine bleach and alkalis have an aggressive effect on silverware, china and crystal; they have issues of product safety; and compliance with regulatory requirements in different geographies necessitates the same.

Although the cleaning performance of these conventional detergent compositions is satisfactory, high phosphate levels, chlorine bleach, and high alkalinity have potential environmental and consumer drawbacks. As a result, an alternative technology was developed to deliver less alkaline products. Similarly, nonphosphated builders are substituted to further improve the environmental profile of the composition, but with less cleaning ability and this is particularly so for stubborn stains such as those caused by tea and coffee themselves or when mixed with dairy products. As a consequence of the reduced cleaning efficiency of the modified composition, various detersive enzymes including amylolytic and proteolytic enzymes have been employed to boost removal of starchy and proteinaceous soils, respectively. Because these enzymes are not compatible with chlorine bleach systems, an oxygen bleaching system has been substituted which can result in a reduction in bleach performance. Often, enzymatic compositions based on oxygen bleaches are formulated with a phosphate builder, in markets where local legislation will allow, to assure good overall performance. An unfortunate weakness in the performance of this alternative technology, is that both formulations are phosphated (i.e., containing inorganic phosphate builder salts) and environmentally undesirable.

Typical cleaning of tea and coffee stains is obtained by the use of such bleaching components in detergents. Bleaching compositions and bleach systems are well known and in the art. Chlorine and N,N,N′,N′-tetraacetylethylenediamine (TAED)/perborate, for example, are well known for their bleaching properties. Cationic bleach systems that include cationic nitrites in the presence of peroxide are also known (see, for example, U.S. Pat. Nos. 5,236,616 and 5,281,361, EP 0 303 520 B1 and WO 99/63038, the contents of which are incorporated herein by their reference). Other known cationic group containing organic bleach activators or bleach catalysts include, for example, cholyl(4-sulfophenyl)carbonate (CSPC, see, for example, U.S. Pat. No. 5,106,528 and EP 399,584 B1), quaternary imine salts (e.g. N-methyl-3,4-dihydroisoquinolinium p-toluenesulfonate, U.S. Pat. Nos. 5,360,568, 5,360,569 and 5,370,826). Several different types of cationic per acid bleach activators have been disclosed in EP 0 699 745, U.S. Pat. Nos. 5,599,781, 5,520,835, the contents of which are incorporated herein by reference. Cationic peroxyacids, such as those described in U.S. Pat. Nos. 5,908,820, 5,422,028, 5,294,362 and 5,292,447, have also shown good bleaching activity over a wide range of pH conditions. Oxygen bleach, specifically perborate in combination with the bleach activator tetraacetylethylenediamine (TAED), has been introduced commercially as a chlorine bleach replacement in certain automatic dishwashing products. However, testing demonstrates that, with or without the TAED component, this bleach system is very poor in its effectiveness, even when used at much higher levels than a chlorine system, on a mass basis.

A number of systems have been described in the art for promoting more effective bleaching, especially by perborate or percarbonate salts. For example, various efforts have been made to improve the efficacy of bleach activators and hundreds of such activators have been described. Bleach activators may, for example, yield unacceptably depositing, foam-forming or malodorous peracids, none of which are acceptable for automatic dishwashing, especially in a spray-action domestic dishwasher. There has been little teaching in the art as to which of the now so numerous bleach activators would be problem-free, and at the same time more effective than TAED.

Accordingly it is an object herein to provide an improved process for the removal of tea coffee and other similar stains without the need for bleach, phosphates, EDTA, or NTA.

It is another object of the invention to provide a method and process for removing coffee, tea and other stains caused by tannins from ceramics, porcelain and the like.

It is yet another object to provide cleaning solutions that are safe, environmentally friendly and economically feasible.

Yet another object is to provide cleaning methods for tea and coffee stain removal than are biodegradable and which includes components which are generally recognized as safe.

Other objects, aspects and advantages of this invention will be apparent to one skilled in the art in view of the following disclosure, the drawings, and the appended claims.

### SUMMARY OF THE INVENTION

Applicants have surprisingly discovered that an acid pre-soak/pre-rinse prior to typical alkaline cleaning of dishware can effectively remove up to one hundred percent of tea and coffee stains, even those that are very old. The invention thus provides methods for washing and cleaning dishware that contains stains from coffee or tea. According to the method a first cleaning step includes a pre-soak in an acid solution at an acidic pH, preferably a pH of less than 2 for a sufficient time and at an appropriate temperature to effectuate stain removal. The time and temperature are not critical but are inversely related. Any acid, organic or inorganic, can be used as long as the pH of the acid solution is low enough or the exposure time is long enough, and further, as long as the nature of the acid will not cause a chemical attack on the substrate. Examples of such acids include but are not limited to citric acid, tartaric acid, lactic acid, ascorbic acid, gallic acid, glycolic acid, urea sulfate, and the like.

The present method provides a method for stain removal and for washing dishes and other ware comprising: (a) soaking or spraying contacting said ware to be washed with an acid solution, said solution having an acidic pH, preferably a pH of 2 or less for a time sufficient for stain removal; (b) optionally rinsing with water, if desired and thereafter, (c) applying a traditional alkaline detergent composition to the dishes, and (d) rinsing with water; wherein the soaking step is performed at a sufficient time and temperature so that stain removal is initiated. The acid pre-soak step loosens the stains so that they can be removed upon rinsing and the traditional alkaline cleaning step. The acid presoak can be performed either outside of a warewash machine, or within a warewash machine as part of a two step process, if appropriate.

In accordance with another of its aspects, the present invention provides a pre-soak composition for use in the above method. Also provided is a detergent system, comprising a presoak composition having an acidic pH, and a detergent composition having alkalinic pH.

Accordingly, in one embodiment, the invention pertains to a method of cleaning dishes and other ware in a dishwashing protocol using an acidic pre-soak composition comprising an acid and an optional surfactant. The invention also pertains, if appropriate, to a method of cleaning articles in a dishwashing machine using an acidic pre-soak composition comprising an acid, and additional functional ingredients such as a surfactant.

### DETAILED DESCRIPTION

So that the invention maybe more readily understood, certain terms are first defined and certain test methods are described.

As used herein, “weight percent,” “wt-%,” “percent by weight,” “% by weight,” and variations thereof refer to the concentration of a substance as the weight of that substance divided by the total weight of the composition and multiplied by 100. It is understood that, as used here, “percent,” “%,” and the like are intended to be synonymous with “weight percent,” “wt-%,” etc.

It should be noted that, as used in this specification and the appended claims, the singular forms “a,” “an,” and “the” include plural referents unless the content clearly dictates otherwise. Thus, for example, reference to a composition containing “a compound” includes a composition having two or more compounds. It should also be noted that the term “or” is generally employed in its sense including “and/or” unless the content clearly dictates otherwise.

As used herein, the term “phosphate-free” refers to a composition, mixture, or ingredient that does not contain a phosphate or phosphate-containing compound or to which a phosphate or phosphate-containing compound has not been added. Should a phosphate or phosphate-containing compound be present through contamination of a phosphate-free composition, mixture, or ingredients, the amount of phosphate shall be less than 0.5 wt %. More preferably, the amount of phosphate is less than 0.1 wt. %, and most preferably, the amount of phosphate is less than 0.01 wt %.

As used herein, the term “phosphorus-free” refers to a composition, mixture, or ingredient that does not contain phosphorus or a phosphorus-containing compound or to which phosphorus or a phosphorus-containing compound has not been added. Should phosphorus or a phosphorus-containing compound be present through contamination of a phosphorus-free composition, mixture, or ingredients, the amount of phosphorus shall be less than 0.5 wt %. More preferably, the amount of phosphorus is less than 0.1 wt. %, and most preferably the amount of phosphorus is less than 0.01 wt %.

“Cleaning” means to perform or aid in soil removal, bleaching, microbial population reduction, rinsing, or combination thereof.

As used herein, the term “ware” includes items such as eating and cooking utensils. As used herein, the term “warewashing” refers to washing, cleaning, or rinsing ware.

The term “about,” as used herein, modifying the quantity of an ingredient in the compositions of the invention or employed in the methods of the invention refers to variation in the numerical quantity that can occur, for example, through typical measuring and liquid handling procedures used for making concentrates or use solutions; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about,” the claims include equivalents to the quantities. All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

The recitation of numerical ranges by endpoints includes all numbers subsumed within that range (e.g. 1 to 5 includes 1, 1.5, 2, 2.75, 3, 3.80, 4, and 5).

### Acidic Pre-Soak/Pre-Rinse Composition

As discussed above, the invention generally relates to a method of cleaning ware, particularly, cups, saucers, dishes etc. that have been stained with coffee or tea in a dishwashing machine using an acid pre-soak. In one embodiment, the method involves using the steps of providing an acidic pre-soak composition comprising an acid and optionally a surfactant. In a traditional ware wash machine, the acid presoak may be inserted into a dispenser in a dishwashing machine, forming a solution with the presoak composition and water, contacting the stain on an article in the dishwashing machine with the wash solution, and rinsing the article. The acid prewash may also be performed wholly outside of the warewash machine and followed by a traditional wash cycle with alkaline detergent. Using a multi tank ware washing equipment it is also possible to apply the acid presoak on the first step followed by the alkaline wash. Also, by using a programmable single tank equipment, it is possible to do the acid presoak step inside the machine as a separate cycle.

Traditionally, acidic detergents have not been used in dishwashing machines because it was believed that they could not effectively remove soils, and hydrophobic soils in particular. However, it has been discovered that an acidic pre-soak prior to a traditional alkaline cleaning can remove stubborn stains such as coffee and tea. Also, using an acidic pre-soak composition has the beneficial side effect of removing mineral deposits from the ware.

The composition of the present invention comprises an acid solution, which can optionally include a surfactant. The composition may optionally include additional functional ingredients that enhance the effectiveness of the composition as a detergent or provide other functional aspects and features to the composition.

In one embodiment the invention includes removing tannic acid stains from dishes and other ware comprising rinsing said dishes with an acid solution; with 1000 to 10,000 ppm of active acid, preferably citric acid or urea sulfate. Allowing the dishes to soak for a period of about 5 to about 60 seconds, then washing with an alkaline solution of about 300 to about 1500 ppm active alkalinity for a period of about 5 to 60 seconds and thereafter rinsing with water for about 5 to about 25 seconds. This can all optionally be programmed into a dishware machine.

### Acid

The pre-soak composition of the present invention comprises an acid. The acid may be a single acid or a mixture of acids. The acid(s) may be a liquid or a solid at room temperature. The acid preferably maintains an overall pH of the wash solution from 0 to 6, more preferably from 0 to 3, and most preferably 2 or less. For a pH of 2 or less, the stained ware should be exposed to the acid presoak for approximately 1 minute or less. As the pH of the presoak solution becomes larger than 2, longer exposure times are needed for a complete stain removal. The concentration of the alkali detergent was normally limited to 300 to 350 ppm of NaOH and the tiles were washed for 45 seconds. When the presoak had a pH>2 the use of an alkaline detergent containing more than 350 ppm of NaOH was preferred. The pH was determined using a pH probe. Additional methods of measuring the concentration of the product can be used. For example, titration can be used to measure the concentration of a product using a standard concentration of another reagent that chemically reacts with the product. This standard solution is referred to as the “titrant.” Performing the titration also requires a method to determine when the reaction that occurs is complete or is brought to a certain degree of completion, which is referred to as the “end point” or more technically the equivalence point. One method that can be used is a chemical indicator which can indicate when the end point is reached. Another method to measure concentration is by using conductivity. Conductivity can be used to determine the ionic strength of a solution by measuring the ability of a solution to conduct an electric current. An instrument measures conductivity by placing two plates of conductive material with known area a known distance apart in a sample. Then a voltage potential is applied and the resulting current is measured. Finally, the concentration can be determined using the pKa and pKb of the composition.

Generally, any acid may be used in the composition of the invention in an amount such that the solution contacting the stain is at a pH of 2 or less. Both organic and inorganic acids have been found to be generally useful in the present composition. Organic acids useful in accordance with the invention include hydroxyacetic (glycolic) acid, citric acid, tartaric acid, lactic acid, ascorbic acid, gallic acid, formic acid, acetic acid, propionic acid, butyric acid, valeric acid, caproic acid, gluconic acid, itaconic acid, trichloroacetic acid, urea sulfate, and benzoic acid, among others. Organic dicarboxylic acids such as oxalic acid, malonic acid, succinic acid, glutaric acid, maleic acid, fumaric acid, adipic acid, and terephthalic acid among others are also useful in accordance with the invention. Any combination of these organic acids may also be used intermixed or with other organic acids which allow adequate formation of the pre-soak composition of the invention. Inorganic acids or mineral acids useful in accordance with the invention include phosphoric acid, sulfuric acid, sulfamic acid, methylsulfamic acid, hydrochloric acid, hydrobromic acid, hydrofluoric acid, and nitric acid among others. These acids may also be used in combination with other inorganic acids or with those organic acids mentioned above. An acid generator may also be used in the composition to form a suitable acid. For example, suitable generators include calcium phosphate, potassium fluoride, sodium fluoride, lithium fluoride, ammonium fluoride, ammonium bifluoride, sodium silicofluoride, etc. In accordance with the preferred embodiment of the present invention the acid is preferably selected from the group consisting of citric, tartaric, lactic, ascorbic, gallic, and glycolic acid.

In another embodiment, if an inorganic or mineral acid is selected as the acid, the acid component of the composition may comprise in the range from about 1 to about 85 wt. % (active acid) of the total pre-soak composition, more preferably in the range of from about 5 to about 75 wt. % of the total pre-soak composition, and most preferably in the range of from about 10 to about 75 wt. % of the total pre-soak composition. In another embodiment, the acid component may comprise up to 100 wt. % of the final pre-soak composition.

### Surfactant

The pre-soak may optionally contain a surfactant or surfactant mixture. These can be selected from water soluble or water dispersible nonionic, semi-polar nonionic, anionic, cationic, amphoteric, or zwitterionic surface-active agents; or any combination thereof. The particular surfactant or surfactant mixture chosen for use in the process and products of this invention can depend on the conditions of final utility, including method of manufacture, physical product form, use pH, use temperature, time required for soaking, and foam control.

The surfactant preferably has from 6 to 30 carbon atoms, more preferably from 10 to 25 carbon atoms and most preferably from 12 to 20 carbon atoms. In accordance with the preferred embodiment of this invention, the surfactant is preferably a nonionic surfactant and a low HLB nonionic surfactant in particular. HLB, or Hydrophilic Lipophilic Balance, refers to a surfactant's solubility in water. An HLB scale was derived as a means for comparing the relative hydrophilicity of amphiphilic molecules. Molecules with an HLB value of 10 or greater indicate that the molecule is hydrophilic and soluble in water. Molecules with an HLB value less than 10 indicate that the molecule is hydrophobic and insoluble in water. The HLB system is well known to skilled surfactant chemists and is explained in the literature such as in the publication, “The HLB System,” ICI Americas (1987). The preferred nonionic surfactants are alcohol ethoxylate nonionic surfactants. The preferred alcohol ethoxylate nonionic surfactants are those that are capped, for example, halogen or benzyl capped. Some non-limiting examples of commercially available alcohol ethoxylate nonionic surfactants include the following: Dehypon LS 54 available from Henkel; Tomadol 91-6, Tomadol 1-9, Tomadol 1-5, and Tomadol 1-3 available from Tomah; Plurafac D-25, and SLF-18 available from BASF; Sasol C13-9EO, Sasol C8-10-6EO, Sasol TDA C13-6EO, and Sasol C6-10-12EO available from Sasol; Hetoxol I-20-10 and Hetoxol I-20-5 available from Laurachem; Huntsman L46-7EO available from Huntman; and Antarox BL 330 and BL 344 available from Rhodia, Pluronic N-3, Plurafac LF-221, Ls-36, Pluronic 25R2, Pluronic 10R5, Novel 1012 GB, Pluronic LD-097, Pluronic D-097, Neodol 25-12. Antarox BL 330 and BL 344 are either branched or straight chain C₁₂-C₁₈ halogen capped alcohol ethoxylate nonionic surfactants. The benzyl capped alcohol exthoxylates are particularly useful in part because they are soluble in most acids, including phosphoric acid, despite not being soluble in water. Despite this preference, the present composition can include one or more of nonionic surfactants, anionic surfactants, cationic surfactants, the sub-class of nonionic entitled semi-polar nonionics, or those surface-active agents which are characterized by persistent cationic and anionic double ion behavior, thus differing from classical amphoteric, and which are classified as zwitterionic surfactants.

A typical listing of the classes and species of surfactants useful herein appears in U.S. Pat. No. 3,664,961 issued May 23, 1972, to Norris. The disclosure of which is hereby incorporated by reference.

### Additional Functional Ingredients

Other active ingredients may optionally be used to improve the effectiveness of the pre-soak composition. Some non-limiting examples of such additional functional ingredients can include: anticorrosion agents, wetting agents, enzymes, foam inhibitors, antiredeposition agents, anti-etch agents, antimicrobial agents and other ingredients useful in imparting a desired characteristic or functionality in the detergent composition. The following describes some examples of such ingredients.

### Method of Cleaning an Article

The method of the present invention involves using the steps of providing an acidic presoak composition comprising an acid and optionally a surfactant, forming a wash solution with the composition and water, contacting a soil on an article with the wash solution, and if desired, rinsing the article, and then washing with a traditional alkaline detergent.

In another embodiment, the method of the present invention involves providing both the acidic pre-soak composition and a traditional alkaline detergent together in a package. In this embodiment, a user would clean articles for a period of time using the acidic pre-soak, and thereafter, the user would switch to the alkaline cleaning compositions.

When carrying out the method of the invention, the acidic pre-soak composition is dispensed onto the dishes. The dispenser may be selected from a variety of different dispensers depending of the physical form of the composition. For example, a liquid composition may be dispensed using a pump, either peristaltic or bellows for example, syringe/plunger injection, gravity feed, siphon feed, aspirators, unit dose, for example using a water soluble packet such as polyvinyl alcohol, or a foil pouch, evacuation from a pressurized chamber, or diffusion through a membrane or permeable surface. If the composition is a gel or a thick liquid, it may be dispensed using a pump such as a peristaltic or bellows pump, syringe/plunger injection, caulk gun, unit dose, for example using a water soluble packet such as polyvinyl alcohol or a foil pouch, evacuation from a pressurized chamber, or diffusion through a membrane or permeable surface. Finally, if the composition is a solid or powder, the composition may be dispensed using a spray, flood, auger, shaker, tablet-type dispenser, unit dose using a water soluble packet such as polyvinyl alcohol or foil pouch, or diffusion through a membrane or permeable surface. The dispenser may also be a dual dispenser in which one component, such as the acid component, is dispensed on one side and another component, such as the surfactant or antimicrobial agent, is dispensed on another side. These exemplary dispensers may be located in or associated with a variety of dish machines including under the counter dish machines, bar washers, door machines, conveyor machines, or flight machines. The dispenser may be located inside the dish machine, remote, or mounted outside of the dishwasher. A single dispenser may feed one or more dish machines.

Once the acidic detergent composition is dispensed, water is added and a pre-soak solution is formed. The wash/pre-soak solution comprises the acidic pre-soak composition and water. The water may be any type of water including hard water, soft water, clean water, or dirty water. The most preferred wash solution is one that maintains the preferred pH ranges of about 0 to about 6, more preferably about 0 to about 4, and most preferably about 0 to about 3.

After the pre-soak/wash solution is formed, the wash solution contacts the stain on an article to be cleaned. Examples of stains include coffee, tea or other tannin-associated stains and beverages made with them. Articles that may be contacted include articles made of glass, plastic, aluminum, steel, copper, brass, silver, rubber, wood, ceramic, porcelain and the like. Articles include things typically found in a dish machine such as glasses, bowls, plates, cups, saucers, pots and pans, bakeware such as cookie sheets, cake pans, muffin pans etc., silverware such as forks, spoons, knives, cooking utensils such as wooden spoons, spatulas, rubber scrapers, utility knives, tongs, grilling utensils, serving utensils, etc. The wash solution may contact the soil in a number of ways including spraying, dipping, sump-pump solution, misting and fogging.

Once contacted, the stains are loosened and then removed from the article by alkaline wash step. The final removal of the soil from the article is accomplished by the alkaline wash.

Once the soil is removed, the articles may be rinsed.

The method can include more steps or fewer steps than laid out here. For example, the method can include additional steps normally associated with a dish machine wash cycle including a wash with a traditional alkaline detergent to remove other soils.

Treatment with Alkaline Detergent after Pre-Soak

In accordance with a preferred embodiment of the invention, the alkaline detergent composition has a high alkalinity. Preferably, the detergent compositions are applied onto the surface of dishes without prior dilution with water.

Said alkaline detergent composition has preferably a pH above about 10.

In accordance with a preferred embodiment of the invention, the application of the alkaline detergent composition follows that of the acidic detergent pre-soak composition. In addition, as one may also appreciate, additional steps of detergent application and rinsing may be added to the above washing sequence.

### Alkaline Detergent

Suitable alkaline agents include but not limited to alkali metal hydroxides, e.g. sodium or potassium hydroxide, sodium and potassium carbonates, and alkali metal silicates, e.g. sodium metasilicate. The level of alkaline agent present in the first component is preferably such that the pH of the use concentration thereof (i.e. the pH applied in the wash zone or step into which the first component is introduced) is in the range of from 8 to 14, more preferably from 10.5-14.

The cleaning agent content of the alkaline detergent may include one or more agents selected from builders (i.e. detergency builders including the class of chelating agents/sequestering agents), bleaches, enzymes and surfactants.

Suitable builder materials (phosphates and non-phosphate builder materials) are well-known in the art and many types of organic and inorganic compounds have been described in the literature. They are normally used in all sorts of cleaning compositions to provide alkalinity and buffering capacity, prevent flocculation, maintain ionic strength, extract metals from soils and/or remove alkaline earth metal ions from washing solutions.

The builder materials usable herein can be any one or mixtures of the various known phosphate and non-phosphate builder materials. Examples of suitable non-phosphate builder materials are the alkali metal citrates, carbonates and bicarbonates; and the salts of nitrilotriacetic acid (NTA); methylglycine diacetic acid (MGDA); serine diacetic acid (SDA); imino disuccinic acid (IDS); dipicolinic acid (DPA); oxydisuccinic acid (ODS); alkyl and alkenyl succinates (AKS); ethylenediamine tetraacetates, oxidized heteropolymeric polysaccharides, polycarboxylates such as polymaleates, polyacetates, polyhydroxyacrylates, polyacrylate/polymaleate and polyacrylate/polymethacrylate copolymers and the terpolymer of polyacrylate/polymaleate and vinylacetate (ex Huls), as well as zeolites; layered silicas and mixtures thereof. Particularly preferred builders are phosphates, citrates, DPA, ODS, alkenyl succinates, carbonates, bicarbonates, the higher molecular weight block copolymers ITA/VA having MW greater than 60,000, maleic anhydride/(meth) acrylic acid copolymers, e.g. Sokalan CP5 ex BASF; NTA and terpolymers, polyacrylate/polymaleate and vinyl acetate (supplied by Huls).

Scale formation on dishes and machine parts are an important problem that needs to be resolved or at least mitigated in formulating a machine warewashing product, especially in the case of low-phosphate (e.g. less than the equivalent of 20% by weight of sodium triphosphate) and phosphate-free machine warewashing compositions, particularly zero-P machine warewashing.

Normally, in a properly built or highly built composition as is conventional, only small amounts of low- to non-foaming nonionic surfactant are present, to aid detergency and particularly to suppress excessive foaming caused by some protein soil. Higher amounts of highly detersive surfactants, such as the high HLB nonionic surfactants, the anionic sulphate or sulphonate surfactants and the alkyl polyglycoside class of surfactants, may be used in low builder-containing active/enzyme-based compositions.

The composition of the alkaline detergent may also include a defoamer. Suitable defoamers include mono- and distearyl acid phosphates, silicone oils, mineral oils, and organic carriers containing long-chain ketones (e.g. the Dehypon series, ex Henkel KGaA, Germany). The composition may include 0.02 to 2% by weight of a defoamer, or preferably 0.05 to 1.0% by weight.

### Bleaching Agent

Suitable bleaches for use in the alkaline cleaning step of the present invention may generally be halogen-based bleaches or oxygen-based bleaches. However, oxygen-based bleaches are preferred.

If no enzyme material is present in the system of the invention, a halogen-based bleach may be effectively used as ingredient of the first component. In that case, said bleach is desirably present at a concentration (as active halogen) in the range of from 0.1 to 10%, preferably from 0.5 to 8%, more preferably from 1 to 6%, by weight. As halogen bleach, alkali metal hypochlorite may be used. Other suitable halogen bleaches are alkali metal salts of di- and tri-chloro and di- and tri-bromo cyanuric acids.

Suitable oxygen-based bleaches are the peroxygen bleaches, such as sodium perborate (tetra- or monohydrate), sodium percarbonate or hydrogen peroxide. These are preferably used in conjunction with a bleach activator which allows the liberation of active oxygen species at a lower temperature. Numerous examples of activators of this type, often also referred to as bleach precursors, are known in the art and amply described in the literature such as U.S. Pat. No. 3,332,882 and U.S. Pat. No. 4,128,494 herein incorporated by reference. Preferred bleach activators are tetraacetyl ethylene diamine (TAED), sodium nonanoyloxybenzene sulphonate (SNOBS), glucose pentaacetate (GPA), tetraacetylmethylene diamine (TAMD), triacetyl cyanurate, sodium sulphonyl ethyl carbonic acid ester, sodium acetyloxybenzene and the mono long-chain acyl tetraacetyl glucoses as disclosed in WO-91/10719, but other activators, such as choline sulphophenyl carbonate (CSPC), as disclosed in U.S. Pat. No. 4,751,015 and U.S. Pat. No. 4,818,426 can also be used.

Peroxybenzoic acid precursors are known in the art as described in GB-A-836,988, herein incorporated by reference. Examples of suitable precursors are phenylbenzoate, phenyl p-nitrobenzoate, o-nitrophenyl benzoate, o-carboxyphenyl benzoate, p-bromophenyl benzoate, sodium or potassium benzoyloxy benzene sulfonate and benzoic anhydride.

Preferred peroxygen bleach precursors are sodium p-benzoyloxy-benzene sulfonate, N,N,N,N-tetraacetyl ethylene diamine (TEAD), sodium nonanoyloxybenzene sulfonate (SNOBS) and choline sulfophenyl carbonate (CSPC).

The amounts of sodium perborate or percarbonate and bleach activator in the first component preferably do not exceed 30% respectively 10% by weight, e.g. are in the range of from 4-30% and from 2-10% by weight, respectively.

### Enzymatic Material

Preferably, an enzyme is present the first component of the system of the invention. Amylolytic and/or proteolytic enzymes would normally be used, the amylolytic enzymes being preferred.

The amylolytic enzymes usable herein can be those derived from bacteria or fungi. Preferred amylolytic enzymes are those prepared and described in GB Patent No. 1,296,839 cultivated from the strains of Bacillus licheniformis NCIB 8061, NCIB 8059, ATCC 6334, ATCC 6598, ATCC 11945, ATCC 8480 and ATCC 9945 A. An example of such amylolytic enzymes is the amylase produced and distributed under the tradename Termamyl by Novo Industri A/S, Copenhagen Denmark. Other suitable types of amylases because of their oxidation stability are Duramyl (ex Novo) and Purafect OxAm (ex Genencor).

These amylolytic enzymes are generally presented as granules or liquids. They may be present in the first component of the system of the invention in amounts such that the final use composition of said component has amylolytic enzyme activity of from 10 to 108 Matose

Units/kilogram, preferably from 102 to 106 MU/kg, and more preferably from 102 to 104 MU/kg.

The amylolytic activity as referred to herein can be determined by the method as described by P. Bernfeld in “Method of Enzymology”, Volume I (1955), page 149.

The proteolytic enzymes usable herein, for instance, the subtilisins which are obtained from particular strains of B. subtilis and B. Lichenifonnis, such as the commercially available subtilisins maxatase, supplied by Gist-Brocades N. V., Delft, Holland, and Alcalase, supplied by Novo Industri A/S, Copenhagen, Denmark. Particularly suitable are proteases obtained from a strain of bacillus having maximum activity through the pH range of 8-12, being commercially available from NOVO Industri A/S under the tradenames of Esperase and Savinase. The preparation of these and analogous enzymes is described in GB Patent No. 1,243,784. These enzymes are generally presented as granules, e.g. marumes, prills, T-granulates, etc., or liquids and may have enzyme activity of from 500 to 6,000 Glycine Units/mg.

The proteolytic enzyme activity can be determined by the method as described by M. L. Anson in “Journal of General Physiology”, Vol. 22 (1938), page 79 (one Anson unit/gram=733 Glycine Units/milligram).

In the compositions of the invention, proteolytic enzymes may be present in amounts such that the final use composition of the first component has proteolytic enzyme activity of from about 10 to 1010 Glycine Units/kilogram, preferably from 102 to 1010 and more preferably from 104 to 109.

Other enzymes, such as lipolytic enzymes, may also be incorporated to improve fat removal. Typical examples of commercial lipolytic enzymes are Lipase YL, Amano CE, Wallerstein AW, Lipase My, and Lipolase ex Novo Industries.

### Other Ingredients

Minor amount of various other ingredients may be present in the chemical cleaning system of the invention. These ingredients include bleach scavengers, anti-foaming agents, solvents, and hydrotropes such as ethanol, isopropanol and xylene sulphonates, flow control agents; enzyme stabilizing agents; soil suspending agents; anti-redeposition agents; anti-tarnish agents; anti-corrosion agents; colorants and other functional additives.

Components of the present invention may independently be formulated in the form of solids (optionally to be dissolved before use), aqueous liquids or non-aqueous liquids (optionally to be diluted before use).

### The Warewashing Process

The inventive chemical cleaning system may be generally utilized in any of the conventional, domestic and institutional, warewashing machines.

However, as mentioned above, both the cleaning system and the warewashing method of the present invention are particularly suitable for use in an institutional mechanical warewashing machine.

Typical institutional warewashing processes are either continuous or non-continuous and are conducted in either a single-tank or a multi-tank/conveyor-type machine.

The first step in our warewashing process is to soak or rinse the wares in the acid solution. This can be done in a number of ways including a dunk tank (submersion) or by spraying the wares with the solution. The wares need to be “soaked” for a period of time for the acid to penetrate the stains. This period of time could be anywhere from 2 seconds to 2 minutes in an institutional machine. In a consumer machine it could be up to 20 minutes. After the acid treatment step, the dishmachine optionally rinses the wares automatically. The next step is to wash the wares in an alkaline wash solution to complete the removal of the stains that were loosened up by the acid. This provides a mechanical action as well as the alkalinity to completely remove the stains. The final step is to rinse the wares with clean water.

Furthermore, each component of the cleaning system of the invention is applied in the warewashing machine using conventional means such as suitable spray nozzles or jets directed upwards and/or downwards toward the dishware.

The present invention will now be further illustrated by way of the following non-limiting examples, in which parts and percentages are by weight unless otherwise indicated.

The invention will now be illustrated by the following non-limiting examples.

### EXAMPLES

### Tea Stain Removal

### Purpose:

To provide a generic method for tea tile cleaning performance in a standard dishmachine.

### Preparation and Standardization of Reagents and Equipment:

Tile Processing/Preparation:
1) To clean a rack of tiles fill and heat up any available dishmachine.
2) Dose in approximately 200 g powdered detergent.
3) Remove 15 tiles from the rack and arrange the remaining tiles so each is facing upward
4) Run cycles on the dish machine until the tiles are fully clean adding more detergent if necessary.
5) Repeat the cleaning step with the 15 tiles that were removed.
6) Once all tiles are clean drain the dishmachine and fill with fresh water.
7) Run a cycle to rinse the tiles with fresh water.
8) Tiles are now ready to be stained/soiled.

Tea Stain/Soil Preparation:
1) Fill tea bath with 17 grain per gallon water and heat water to 180° F. using steam line.
2) Unwrap 150 bags of Lipton black tea and remove the strings from each bag.
3) Put bags in tea bath and agitate for five minutes.
4) Remove tea bags and discard.
5) Cool bath to 155-160° F.
6) If making tea soil add 4 cans of sweetened condensed milk to the bath and allow to mix for 30 minutes.
7) Maintain temperature of 155-160° F. and add DI water as needed to keep bath full.
8) Turn on air line leading to tea bath.
9) Raise the tile rack by pressing and holding the metal switch on the side of the controller and unplug to keep the rack raised. Place tiles into each slot.
10) Plug controller in and reset the dip count. Begin the staining process by lowering the tile rack into the bath using the metal switch. The tiles will be lowered into the tea solution for one minute, and then raised up for one minute.
11) Controller will automatically stop the dipping after 25 dip/raise cycles.
12) Remove tiles and allow to air dry for three days or bake in an oven at 180° F. for two hours before testing.
13) If more batches of tiles are required, check that the bath is full and at the correct temperature and repeat steps 9-12 for each successive rack of tiles.
14) When staining is completed drain and clean the bath of tea residue using a dilute solution of liquid caustic and water.

### Procedure:

Tile Evaluation:
1) Once testing has been completed tiles are ready for evaluation. Post clean photos should be taken. Each picture should contain the control set(s) and one of the experimental sets.
2) Tile evaluation is done by comparing each set of tested tiles back to the control set(s), and determining if the experimental set is more clean, less clean, or the same as the control set(s).
3) The comparison should be done as an average of the entire set without focusing on single tiles within the sets.

Tile samples were prepared and tested as described. Testing descriptions are provided in Table 1.

TABLE 1

| | TREATMENT | TIME | | COMMENT |
|---|---|---|---|---|
| 1 | Step 1 - 200 ppm of | 20 | minutes | tea stain remained |
| | ascorbic acid and 330 ppm | | | |
| | NaOH solution | | | |
| 2 | Step 1 - 1000 ppm of | >15 | minutes | faint tea stain |
| | Na₂SO₃ and 330 ppm of | | | remained |
| | NaOH | | | |
| 3 | Step 1 - 1000 ppm | 7 | minutes | tea stain remained |
| | sodium metabisulfite and | | | |
| | 330 ppm NaOH | | | |
| 4 | Step 1 - 1000 ppm of | 7 | minutes | tea stain remained |
| | sodium metabisulfite | | | |
| | Step 2 - 330 ppm NaOH | 2 | minutes | |
| 5 | Step 1 - 1000 ppm | <1 | minutes | tea stain remained |
| | ascorbic acid | | | |
| | Step 2 - 330 ppm NaOH | 2 | minutes | |
| 6 | Step 1 - 100 ppm | 5 | minutes | tea stain remained |
| | ascorbic acid | | | |
| | Step 2 - 330 ppm NaOH | 2 | minutes | |
| 7 | Step 1 - 100 ppm citric | 4 | minutes | tea stain remained |
| | acid | | | |
| | Step 2 - 330 ppm NaOH | 2 | minutes | |
| 8 | Step 1 - glycolic acid 100 ppm | 4 | minute | tea stain remained |
| | Step 2 - NaOH 330 ppm | 2 | minutes | |
| 9 | Step 1 - 500 ppm sodium | 45 | seconds | tea stain remained |
| | sulfite | | | |
| | Step 2 - 330 ppm NaOH | | | |
| 10 | Step 1 - 500 ppm Na | 45 | seconds | tea stain remained |
| | ascorbate | | | |
| | Step 2 - 1650 ppm NaOH | | | |
| 11 | Step 1 - 250 ppm sodium | 45 | seconds | tea stain remained |
| | ascorbate | | | |
| | Step 2 - 1650 ppm | | | |
| | NaOH | | | |
| 12 | Step 1 - 100 ppm sodium | 45 | seconds | tea stain remained |
| | ascorbate | | | |
| | Step 2 - 1650 ppm | | | |
| | NaOH | | | |
| 13 | Step 1 - 50 ppm sodium | 45 | seconds | tea stain remained |
| | ascorbate | | | |
| | Step 2 - 1650 ppm | | | |
| | NaOH | | | |
| 14 | Step 1 - 50 ppm sodium | 45 | seconds | tea stain remained |
| | ascorbate | | | |
| | Step 2 - 330 ppm NaOH | | | |
| 15 | Step 1 - 500 ppm sodium | 45 | seconds | tea stain remained |
| | ascorbate | | | |
| | Step 2 - 330 ppm NaOH | | | |
| 16 | Step 1 - 1000 ppm | 45 | seconds | tea stain remained |
| | sodium ascorbate, | | | |
| | Step 2 - 330 ppm NaOH | | | |
| 17 | 1650 ppm NaOH | 45 | seconds | tea stain remained |
| 18 | NaOH; NaC1 | 45 | seconds | tea stain remained |
| 19 | Step 1 - 100 ppm citric | 2 | minutes | tea stain remained |
| | acid | | | |
| | Step 2 - 330 ppm NaOH | 45 | seconds | |
| 20 | Step 1 - 100 ppm citric | 4 | minutes | tea stain remained |
| | acid | | | |
| | Step 2 - 330 ppm NaOH | 45 | seconds | |
| 21 | Step 1 - 200 ppm citric | 5 | minutes | perfectly clean |
| | acid | | | |
| | Step 2 - 330 ppm | 45 | seconds | |
| | NaOH, | | | |
| 22 | Step 1 - 100 ppm | 7 | minutes | perfectly clean |
| | glycolic acid, | | | |
| | Step 2 - 330 ppm NaOH, | 45 | seconds | |

As can be seen, increasing the time of exposure of the tea stain to the acid solution (compare experiment 8 to experiment 22) enable the removal of the stain by the further treatment with the alkaline solution. The use of very weak acids (experiment 1) even at long exposure times can not affect the stain so it can be removed by the alkaline step.

### Part III

Tea Stain Removal Tests with Citric Acid P Six solutions containing different concentrations of citric acid were prepared with 50% citric acid and water.

A. 12 g of 50% citric acid per 200 g of solution→30,000 ppm, pH=1.98

B. 10 g of 50% citric acid per 200 g of solution→25,000 ppm, pH=1.99

C. 8 g of 50% citric acid per 200 g of solution→20,000 ppm, pH=2.03

D. 6 g of 50% citric acid per 200 g of solution→15,000 ppm, pH=2.08

E. 4 g of 50% citric acid per 200 g of solution→10,000 ppm, pH=2.14

F. 2 g of 50% citric acid per 200 g of solution→5,000 ppm, pH=2.28

G. 1 g of 50% citric acid per 200 g of solution→2500 ppm, pH=2.51

For each of the solutions, a tea stain tile was placed in 200 ml of the test solution for 1 minute at room temperature. The pH of the solution was measured with a pH meter. After placing the tile in the acid pre-soak, the tile was then rinsed with distilled H₂0 and then immersed in 330 ppm caustic solution for 45 seconds. The temperature of the caustic solution was similar to the temperature of wash water in a warewashing machine (T≈140° F.). The same procedure was repeated for solutions B-G.

### Results:

Tile 1 bottom half was tested with Solution A (30,000 ppm citric acid)

Tile 1 top half was tested with Solution D (15,000 ppm citric acid).

Tile 2 bottom was tested with Solution B (25,000 ppm)

Tile 2 top was tested with Solution E (10,000 ppm)

Tile 3 bottom was tested with Solution C

Tile 3 top was tested with Solution F

Tile 6 was tested with Solution G (2500 ppm, citric acid).

Tiles 1, 3 and 6 were perfectly clean. Tile 2 was clean but seemed to have a tiny bit of blue residue. This was not tea stain, it was likely to be residue from other testing. Thus all solutions of citric acid cleaned the tea stains completely.

What is claimed is:

1. A method of removing tea, coffee and other such stains from dishware comprising:
contacting said dishware with an acidic solution for a sufficient time so that stains can be removed by an alkaline washing.

2. The method of claim 1 wherein said acidic solution has a pH of about 2.

3. The method of claim 1 wherein said acid is selected from the group consisting of:
citric acid, tartaric acid, glycolic acid, lactic acid, ascorbic acid, urea sulfate, and gallic acid, or combinations thereof.

4. A dishwashing method comprising:
applying an acid pre-soak composition to the dishes, and thereafter,
applying an alkaline liquid detergent composition to the dishes, and
rinsing with water; wherein said alkaline detergent composition has a pH above about 10 and the acidic detergent composition has pH lower than about 6; the compositions being applied to the dishes without dilution or after being diluted with water such that once applied to the dishes the compositions impart an acidic or alkaline pH, respectively, to the surfaces of the dishes.

5. A method according to claim 4, wherein said acidic pre-soak composition has a pH of about 0-2.

6. A method according to claim 4, wherein said acidic pre-soak composition has a pH of 2 or less.

7. The method of claim 4 wherein said acidic pre-soak composition is phosphate free.

8. The method of claim 4 wherein said acid comprises an organic or inorganic acid or a mixture thereof.

9. The method of claim 4 wherein said acid comprises citric acid.

10. The method of claim 4 wherein said acid comprises urea sulfate.

11. The method of claim 4 wherein said acid presoak composition further comprises a surfactant.

12. The method of claim 4 wherein said acid presoak composition further comprises a corrosion inhibitor or anti-corrosion agent.

13. A detergent system for use in a dishwashing method according to claim 4 comprising two compositions, one being an acidic pre-soak composition having pH below about 4, and the other being an alkaline detergent composition having pH above about 9, wherein the pre-soak is applied for a certain time and temperature so that tea, coffee and other stains can be removed by the application of the alkaline detergent.

14. A method for removing tannic acid stains from dishes and other ware comprising:
rinsing or immersing said dishes with an acid solution;
allowing said dished to soak, for a time sufficient to loosen said stains, and thereafter washing said dishes in an alkaline solution, and finally, rinsing said dishes with water.

15. The method of claim 14 wherein said rising step includes the use of a rinse aid.

16. The method of claim 14 wherein said acid comprises an organic or inorganic acid or a mixture thereof.

17. The method of claim 16 wherein said acid solution comprises citric acid and urea sulfate.

18. The method of claim 14 wherein alkaline wash time is from 0 to about 80 seconds.

19. The method of claim 14 wherein said final rinse is from about 5 to about 25 seconds.
